(19) United States
(12) Patent Application Publication
(10) Pub. No.: US 2015/0362608 A1
(43) Pub. Date: Dec. 17, 2015

(54) COMBINED INTERPOLATION AND PRIMARY ESTIMATION

(71) Applicant: PGS Geophysical AS, Oslo (NO)

(72) Inventor: Gert-Jan Adriaan van Groenestijn, Leiden (NL)

(21) Appl. No.: 14/619,487

(22) Filed: Feb. 11, 2015

Related U.S. Application Data
(60) Provisional application No. 62/013,370, filed on Jun. 17, 2014.

(51) Int. Cl. G01V 1/28

(52) U.S. Cl. CPC G01V 1/28; G01V 2210/57

(57) ABSTRACT

A method for combined interpolation and primary estimation can include performing a plurality of interpolations on received seismic data, performing a plurality of primary estimations on the received seismic data, and performing a combination of interpolation and primary estimation. Performing the combination can include generating reestimated primaries via a second primary estimation with input of a second interpolation, where output of the first primary estimation is input to the second interpolation.

### CROSS-REFERENCE TO RELATED APPLICATIONS

This application claims priority to U.S. Provisional Application 62/013,370, filed Jun. 17, 2014, which is incorporated by reference.

### BACKGROUND

In the past few decades, the petroleum industry has invested heavily in the development of marine seismic survey techniques that yield knowledge of subterranean formations (also referred to as “subsurface formations” or simply “subsurface”) beneath a body of water in order to find and extract valuable mineral resources, such as oil. High-resolution seismic images of a subterranean formation are helpful for quantitative seismic interpretation and improved reservoir monitoring. For a typical marine seismic survey, a marine seismic survey vessel tows one or more seismic sources below the surface of the water and over a subterranean formation to be surveyed for mineral deposits. Seismic receivers (such as geophones or hydrophones) may be located on or near the water bottom, on one or more streamers towed by the source vessel, or on one or more streamers towed by another vessel. A seismic source vessel typically contains marine seismic survey equipment, such as navigation control, seismic source control, seismic receiver control, and recording equipment.

The seismic source control may cause the one or more seismic sources, which can be air guns, marine vibrators, etc., to produce acoustic signals at selected times (often referred to as “firing a shot” or “shooting”). Each acoustic signal is essentially a sound wavefield that travels through the water, interacts with the subterranean formation, and is ultimately detected by the seismic receivers. The seismic receivers thereby measure a wavefield that was initiated by the actuation of the seismic source. In this sense, the acoustic signals (or “shots”) are fired at the seismic receivers and the seismic receivers measure a wavefield based on the actuation of the seismic sources.

### BRIEF DESCRIPTION OF THE DRAWINGS

FIG. 1 illustrates an example of a two-dimensional matrix representation of combinations of seismic sources and seismic receivers actually or potentially contributing to seismic data according to one or more embodiments of the present disclosure.

FIG. 2 illustrates examples of primaries and multiples determined from input from a combination of seismic sources and seismic receivers and a number of examples of combined interpolation and primary estimation according to one or more embodiments of the present disclosure.

FIG. 3 illustrates examples of primaries and multiples determined from input from a combination of seismic sources and seismic receivers and a number of examples of combined interpolation and primary estimation according to one or more embodiments of the present disclosure.

FIG. 4 illustrates examples of primaries and multiples determined from input from a combination of seismic sources and seismic receivers and a number of examples of combined interpolation and primary estimation according to one or more embodiments of the present disclosure.

FIG. 5 illustrates a flowchart of an example of combined interpolation and primary estimation according to one or more embodiments of the present disclosure.

FIG. 6 illustrates a flowchart of an example of combined interpolation and primary estimation according to one or more embodiments of the present disclosure.

FIG. 7 illustrates a method flow diagram for combined interpolation and primary estimation according to one or more embodiments of the present disclosure.

FIG. 8 illustrates a diagram of a system for combined interpolation and primary estimation according to one or more embodiments of the present disclosure.

FIG. 9 illustrates a diagram of a machine for combined interpolation and primary estimation according to one or more embodiments of the present disclosure.

### DETAILED DESCRIPTION

In order to locate or monitor reservoirs in the subsurface that contain oil and/or petroleum gas or can store CO₂, among other materials of interest, an image of the subsurface may be useful. Marine seismic survey techniques can be used to obtain or enhance these images. Marine seismic survey techniques, as often implemented, can be divided into several stages. During a seismic acquisition stage, a seismic source at or close to an air-water interface, such as a sea surface, generates a wavefield. This wavefield can propagate through a subsurface where it can be partly reflected at places where two layers with different elastic properties meet, for instance, at an interface between sea water and the bottom of the sea or an interface between subsurface layers with different elastic properties (e.g., a salt layer or dome, oil, petroleum gas, air, CO₂, etc.).

The reflections can be measured by seismic receivers. As would be understood by one of ordinary skill in the art with the benefit of this disclosure, embodiments and advantages described herein with reference to seismic receivers for marine geophysical prospecting might be equally achievable and advantageous when used with ocean bottom cable (OBC) or nodes or with a water surface or near-water-surface streamer. In various embodiments, a plurality of seismic receivers may be disposed on one or more near-water-surface streamers, one or more OBCs, a plurality of nodes near or on the water bottom, or any combination thereof. In some examples, as an alternative and/or in addition, seismic receivers located on nodes near or on the water bottom may be used to detect and/or record signals to be processed according to the present disclosure.

In particular, the present disclosure is related to combined interpolation and primary estimation. A source of an acoustic signal can generate a wavefield and can be termed a seismic source. Such seismic sources can include a number of air guns, water guns, explosive devices, and/or vibratory devices, among others. The wavefield constitutes pressure variations in a fluid as a function of time to create an impulse response caused by a transient perturbation of pressure by an acoustic signal (impulse) generated by actuation of the seismic source. This can be repeated with more than one seismic source at different source positions. In a seismic processing stage, an image of the subsurface can be constructed from the measured reflections.

A primary impulse response, which is referred to herein as a “primary” in the singular and “primaries” in the plural, can be defined as a wavefield that has been reflected by a single interface (in the subsurface, at the water bottom, at the sea surface, etc.) before being detected by a seismic receiver. For example, a water bottom primary has bounced once at the interface between the water and the subsurface, while a subsurface primary has bounced once at an interface between layers in the subsurface. A multiple impulse response, which is referred to herein as a “multiple” in the singular and “multiples” in the plural, can be defined as a wavefield that has been reflected by more than one interface before being detected by a seismic receiver. The number of bounces determines the multiple's order. That is, a wavefield that has bounced once at the sea surface, and has been reflected twice by the subsurface interface, can be termed a first order multiple and a wavefield that has bounced twice at the sea surface, and has been reflected thrice by the subsurface interface, can be termed a second order multiple. Primary and multiple impulse responses can overlap such that construction of an image of the subsurface from the measured reflections can be complicated. As such, there are a number of methods for separation or removal of multiples to yield desired estimates of primaries.

Primary estimation can be computationally demanding and/or labor intensive when implemented by itself, such as when using an estimation of primaries by inversion technique, for example, an estimation of primaries by sparse inversion (EPSI). Moreover, using a two-step approach that makes calculations to predict multiples and then subtracts them, such as when using the surface-related multiple elimination (SRME) algorithm, also can be computationally demanding and/or labor-intensive.

Some approaches to using wave equation-based primary estimation techniques (such as SRME) and estimation of primaries by inversion (such as EPSI) on three-dimensional (3D) seismic data include compensation for more seismic data (from seismic source-receiver combinations) than acquired and/or received as data input. The seismic data from missing seismic source-receiver combinations in these approaches may be interpolated before applying a primary estimation technique.

In contrast, various embodiments of the present disclosure include combining interpolation into the primary estimation, such that each of the two techniques can make use of the information generated by the other. Alternatively and/or additionally, various embodiments can include interpolation being incorporated inside an primary estimation by inversion, such that during the inversion not everything has to be calculated, with portions being interpolated, to provide higher computationally efficiency. As such, the present disclosure describes techniques that reduce computational and/or labor costs by combining interpolation and primary estimation. For example, a primary estimation technique such as EPSI can be combined with an interpolation technique such as differential normal move out (differential NMO).

A differential NMO technique can be used in seismic processing to compensate for the effects of separation (offset) between seismic sources and seismic receivers in the case of horizontal offset. The differential NMO is a function of time and offset that can be used in seismic processing to compensate for the effects of normal move out, or the delay in reflection arrival times when seismic sources and seismic receivers are offset from each other. A NMO velocity can be calculated when the offset and two-way travel times at zero and non-zero offset are known. The NMO velocity can be used to remove the effect of offset on the travel times. The NMO velocity can be used for two-dimensional (2D) and 3D interpolations for points where travel times have not been measured (non-received seismic data) between points where travel times have been measured (received seismic data). In addition, NMO correction can be used as a seismic processing tool to distinguish between reflections and other events such as refractions, diffractions, and multiples.

Accordingly, as described herein, a method for combining interpolation and primary estimation can include performing a plurality of interpolations on received seismic data, performing a plurality of primary estimations on the received seismic data, and performing a combination of interpolation and primary estimation. Performing the combination can include generating reestimated primaries via a second primary estimation with input of a second interpolation, where output of the first primary estimation is input to the second interpolation.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a”, “an”, and “the” include singular and plural referents, unless the context clearly dictates otherwise, as do “a number of”, “at least one”, and “one or more”. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected.

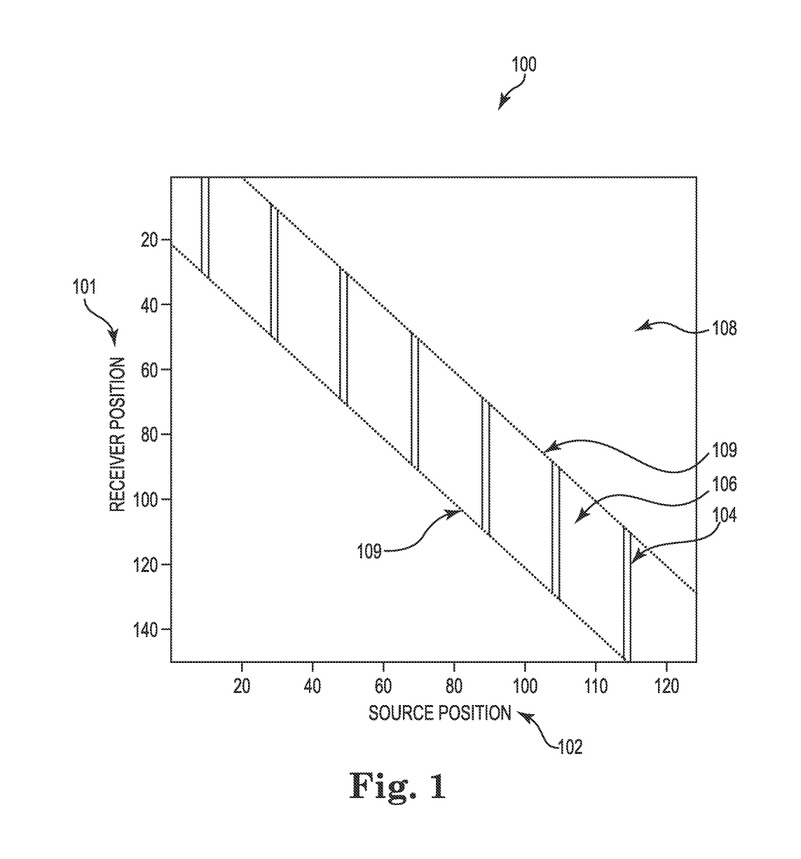

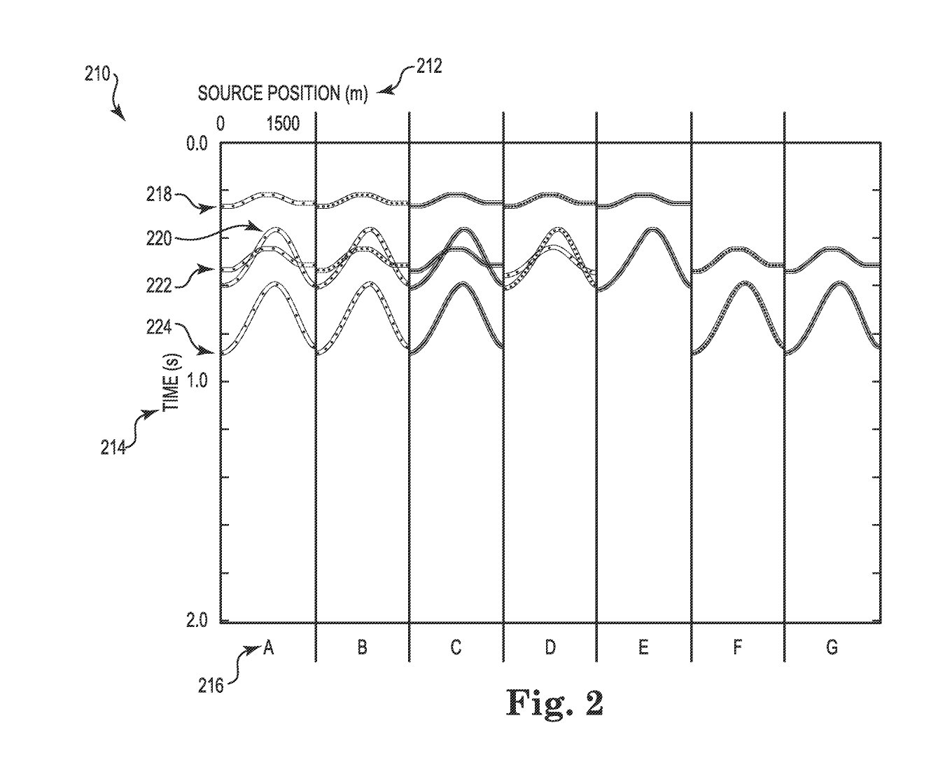

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 208 in FIG. 2. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present disclosure and should not be taken in a limiting sense.

FIG. 1 illustrates an example of a two-dimensional matrix representation of combinations of seismic sources and seismic receivers actually or potentially contributing to seismic data according to one or more embodiments of the present disclosure. A matrix 100 in FIG. 1 shows which seismic source-receiver combination positions are actually present or potentially can be present in the 2D dataset. The y axis of the matrix 100 schematically illustrates positioning 101 of more than 140 actual seismic receivers and the x axis schematically illustrates positioning 102 of more than 120 actual or potential seismic sources. Each of the 120 actual or potential seismic sources is capable of independently producing an acoustic signal. In actual practice, subsets of the 120 actual or potential seismic sources may be fired simultaneously or in a coordinated scheme to produce one or more acoustic signals with desired frequency and amplitude characteristics. As such, a vertical separation between the diagonal lines 109 can indicate that a particular actual or potential seismic source consistent with this configuration would be positioned to have its generated acoustic signal detected and/or measured by a particular group of seismic receivers.

An example of a seismic source-receiver combination position is indicated at 104 for which a trace actually exists in the input data due to a seismic source actually generating an acoustic signal detected and/or measured by a particular group of seismic receivers. An example is indicated at 106 of a missing trace at a potential seismic source-receiver combination position that may be desired in order to run a successful primary estimation. An example is indicated at 108 of a seismic source-receiver combination position for which a trace may not be needed in order to run a successful primary estimation.

FIG. 2 illustrates examples of primaries and multiples determined from input from a combination of seismic sources and seismic receivers and a number of examples of combined interpolation and primary estimation according to one or more embodiments of the present disclosure. As described herein, missing traces (see FIG. 1 at potential seismic source-receiver combination positions 106) can, in various embodiments, be interpolated by an interpolation technique (e.g., differential NMO) in combination with the primary estimation technique (e.g., EPSI). Various results 210 of a number of embodiments of this are schematically illustrated in FIG. 2 in the zero-offset plotted panels A through G shown at 216.

Each zero-offset plotted panel A through G at 216 in FIG. 2 shows on the x axis possible seismic source positions 212 for actual or interpolated seismic data spread out over a range of 0 to 1500 meters (m). The y axis shows zero-offset travel times 214 of acoustic signals generated and detected by the actual or interpolated seismic source-receiver combinations. A range of 0.0 to 2.0 seconds (s) is shown to cover the time between generation of the acoustic signal and detection of various types of reflection.

For example, received seismic data plotted in panel A shows a water bottom primary 218, a subsurface primary 220, possibly having reflection characteristics different from the reflection characteristics of the water bottom, such as a salt dome, a first order multiple of the water bottom primary 222, and a first order multiple of the subsurface primary 224. To simplify the presentation herein, other primaries and first and higher order multiples have been removed from the illustrations shown in FIGS. 2-4. Ten actual seismic sources (represented by dots in each of primaries 218 and 220 and multiples 222 and 224) evenly spread over the 0 to 1500 m range can produce the results for the primaries 218, 220 and multiples 222, 224 shown in panel A of FIG. 2.

Panel B of FIG. 2 shows interpolation of missing traces in panel A. The missing traces can, for example, be interpolated by positioning a potential seismic source between each of the 10 actual seismic sources from panel A to yield a total of 19 traces (represented by dots in each of primaries 218 and 220 and multiples 222 and 224). Compared to the received seismic data in panel A, the single preliminary interpolation scheme illustrated in panel B sometimes may be considered successful for the primary events. However, examination of the resultant multiples often can show that the NMO velocity used in the differential NMO interpolation has not been close enough to an actual move out velocity, such that the output of the multiples, for example, 222 and 224 in panel B, based upon the single preliminary interpolation may be considered unsuccessful.

A primary estimation operation can be run on the dataset from panel B for a number of iterations (e.g., 20-60 iterations) to provide an improved primary estimation result and/or an improved separate multiple estimation result, as shown in panels D and F, respectively, of FIG. 2. The improvement in the primaries 218, 220 and multiple 222, 224 traces in panels D and F is represented by an increase in the number of dots relative to panel B. However, as illustrated in panel D, some energy from the first order multiple of the water bottom primary 222 has leaked into the subsurface primary 220 result to possibly obscure the subsurface primary 220. This can happen, for example, at the location of the traces where the NMO velocity used in the differential NMO interpolation has not been close enough to the actual move out velocity.

The primary estimations shown in panel D and the multiple estimations shown in panel F can be further improved. That is, the separate primary and multiple datasets from the iterations of the primary estimation operation shown in panels D and F can be interpolated. As such, the entire dataset (primaries plus multiples) is not interpolated together, but the primary and multiple estimations are interpolated separately. Each of the separate interpolations of the primary and multiple datasets can, in various embodiments, be performed with their own appropriate and different NMO velocities. The improvement in the traces for the primaries 218, 220 and the multiples 222, 224 in panels E and G is represented by solid lines relative to the number of dots in panels D and F, respectively. The two improved estimation results based upon the second round of interpolation shown in panels E and G can be combined to show the improved estimation results for the primaries and the multiples together in panel C.

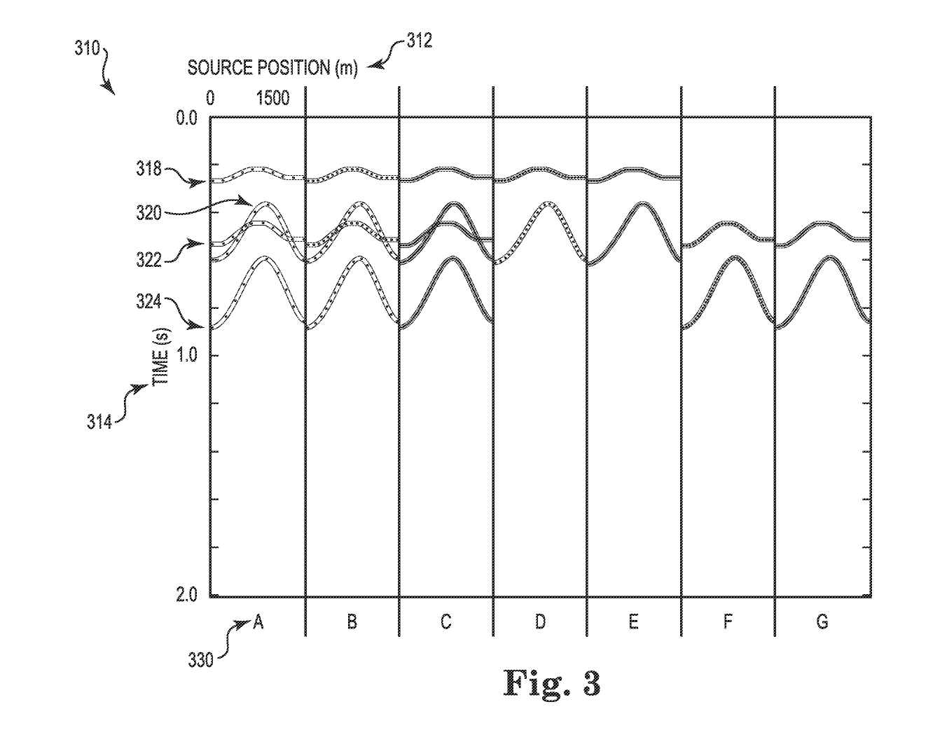

FIG. 3 illustrates examples of primaries and multiples determined from input from a combination of seismic sources and seismic receivers and a number of examples of combined interpolation and primary estimation according to one or more embodiments of the present disclosure. As described herein, missing traces (see FIG. 1 at potential seismic source-receiver combination positions 106) can, in various embodiments, be interpolated by an interpolation technique in combination with the primary estimation technique. Various results 310 of a number of embodiments of this are schematically illustrated in FIG. 3 in the zero-offset plotted panels A through G shown at 330.

For example, received seismic data plotted in panel A shows a water bottom primary 318, a subsurface primary 320, possibly having reflection characteristics different from the reflection characteristics of the water bottom, a first order multiple of the water bottom primary 322, and a first order multiple of the subsurface primary 324. Ten actual seismic sources (represented by dots in each of primaries 318 and 320 and multiples 322 and 324) evenly spread over the 0 to 1500 m range can produce the results for the primaries 318, 320 and multiples 322, 324 shown in panel A of FIG. 2.

Panel B of FIG. 3 shows interpolation by differential NMO of missing traces in panel A. The missing traces can, for example, be interpolated by positioning a potential seismic source between each of the 10 actual seismic sources from panel A to yield a total of 19 traces (represented by dots in each of primaries 318 and 320 and multiples 322 and 324). Compared to the received seismic data in panel A, the single preliminary interpolation scheme illustrated in panel B sometimes may be considered successful for the primary events. However, examination of the resultant multiples often can show that the NMO velocity used in the differential NMO interpolation has not been close enough to actual move out velocity, such that the output of the multiples, for example, 322 and 324 in panel B, based upon the single preliminary interpolation may be considered unsuccessful.

As described herein, secondary primary estimation operations can be run on the separate datasets represented by panels E and G of FIG. 2 for a number of iterations (e.g., 20-60 iterations) to provide an improved primary estimation result and an improved separate multiple estimation result, as shown in panels D and F, respectively, of FIG. 3. The improvement in the primary 318, 320 and multiple 322, 324 traces in panels D and F is represented by an increase in the number of dots relative to panel B. In contrast to panel D of FIG. 2, panel D of FIG. 3 shows that the first round of interpolation and primary estimation described with regard to FIG. 2 combined with the secondary primary estimation operation has reduced the amount of energy leaking from the first order multiple of the water bottom primary 322 into the subsurface primary 320.

In various embodiments, the primary estimations shown in panel D and the multiple estimations shown in panel F resulting from application of secondary primary estimation operations can be further improved. That is, the separate primary and multiple datasets from the secondary iterations of the primary estimation operation shown in panels D and F can be interpolated. As described with regard to FIG. 2, the entire dataset of primaries plus multiples is not reinterpolated together, but the primary and multiple estimations are interpolated separately. That is, each of the separate reinterpolations of the primary and multiple datasets can, in various embodiments, be performed with their own appropriate and different NMO velocities. The improvement in the traces for the primaries 318, 320 and the multiples 322, 324 in panels E and G is represented by solid lines relative to the number of dots in panels D and F, respectively. The two improved estimation results based upon the second round of primary estimation and interpolation shown in panels E and G can be combined to show the improved estimation results for the primaries and the multiples together in panel C.

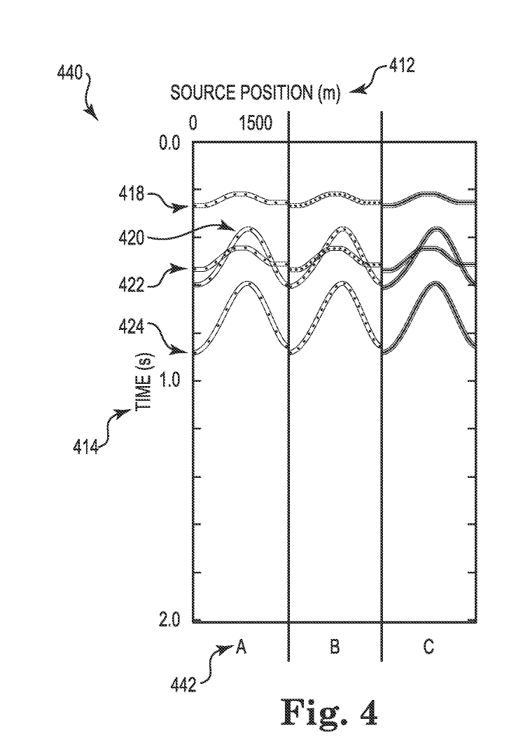

FIG. 4 illustrates examples of primaries and multiples determined from input from a combination of seismic sources and seismic receivers and a number of examples of combined interpolation and primary estimation according to one or more embodiments of the present disclosure. Some embodiments of combined interpolation and primary estimation, as described in the present disclosure, can include portions of the interpolation incorporated into portions of the primary estimation having the highest computational costs when performed strictly based upon, for example, calculations of updated (phase) directions of the primary impulse responses and/or updated scaling thereof. That is, in various embodiments, in order to reduce computational complexity, an interpolated update direction of a primary impulse response can be substituted for at least one calculation of an update direction thereof and/or an interpolated scaling factor can be substituted for at least one calculation of a scaling factor to scale the update, such that an objective function value decreases, for example.

Results 440 of this reduction of computational complexity are schematically illustrated in FIG. 4 in the zero-offset plotted panels A through C shown at 442. The embodiment illustrated with regard to FIG. 4 can, for example, utilize the same received seismic data as that illustrated in FIG. 1. Thus, panels A and B of FIG. 4 show the same results for the received seismic data and the preliminary interpolation, respectively, as illustrated in FIGS. 2 and 3.

An example embodiment of having portions of the interpolation incorporated into the calculations of the update direction of the primary impulse responses and/or its scaling is presented as follows. Where Nₛ is a number of seismic sources in the dataset following preliminary interpolation (for example, the number of dots representing seismic sources in panel B compared to panel A), N_{rc} is a number of seismic receivers per acoustic signal (a desired number of seismic receivers per acoustic signal after the preliminary interpolation based upon the seismic receivers being appropriate for detection and/or measurement of the acoustic signal generated by the seismic source), and N_{f} is a number of relevant seismic frequencies, a number of calculations per iteration for each of the update and the scaling is:

N_{calc}=Nₛ×N_{rc}×N_{rc}×N_{f} (1)

In an example with a 2D dataset (for example, as described with regard to FIG. 1), the values may be Nₛ=150, N_{rc}=39, and N_{f}=270. Because there are Nₛ×N_{rc} seismic source-receiver combinations (see seismic source-receiver combination positions 104 in FIG. 1), for each seismic source-receiver combination, N_{rc}×N_{f} calculations may be useful.

By incorporating interpolation therein, an update direction of the primary impulse response and/or a scaling thereof may not have to be calculated for all of the seismic source-receiver combination positions 104 for which a trace actually exists and the potential seismic source-receiver combination positions 106 for which a missing trace may be desired, as shown in FIG. 1. For example, the update direction of the primary impulse responses may be calculated and/or the corresponding scaling may, in some embodiments, be calculated only for the points corresponding to seismic source-receiver combination positions 104 in FIG. 1, and differential NMO may be used to interpolate the calculations for the points corresponding to potential seismic source-receiver combination positions 106 in FIG. 1. Where R is a ratio between a number of points corresponding to seismic source-receiver combination positions 104 and potential seismic source-receiver combination positions 106, the number of calculations before interpolation can be determined by:

N_{calc,R}=R×Nₛ×N_{rc}×N_{rc}×N_{f} (2)

Where Nₜ is a trace length in samples, the differential NMO calculation, using sinc interpolation for the remaining seismic source-receiver combinations, will have a number of calculations per iteration that can be determined by:

N_{calc,difamo}=(1−R)×Nₛ×N_{rc}×N_{d}×Nₜ (3)

As used herein, a length of a trace recorded by one seismic receiver resulting from one acoustic signal can be expressed as a period of time, for example, up to 2.0 s as shown in FIGS. 2-4. However, the information in the trace may be digital, and samples can be acquired incrementally with short time intervals. As such, a trace length of 2.0 s that is sampled every 4 milliseconds (ms) would yield a trace length of 501 samples. For example, this sinc interpolation is based on the Whittaker-Shannon interpolation formula and is a technique to construct a continuous-time band-limited function from a sequence of real numbers.

For the 2D dataset in FIG. 1, values for the elements in equation 3 can be R=0.1, N_{d}=12, and Nₜ=501. Combination of interpolation by differential NMO into primary estimation by EPSI can perform the update direction of the primary impulse response and/or a scaling thereof in a fraction of the computation time for calculation thereof by EPSI. The Fraction can be calculated by:

Fraction=R+(1−R)×N_{d}×Nₜ/(N_{rc}×N_{f}) (4)

In some embodiments, numbers for N_{f} and Nₜ may be of the same order, and N_{d} may not be larger than 12, where the sinc interpolation provides 12 interpolations to provide the desired results. For field data, using large numbers for N_{rc} may bring (1−R)×N_{d}×Nₜ/(N_{rc}×N_{f}) close to zero, so that the Fraction in equation 4 will be close to the value of R. That is, the reduced computation time will be close to R times the EPSI only computation time. For the 2D data where N_{rc}=39, the Fraction determined by equation 4 can be 0.61, as described above. Moreover, as illustrated in panel C of FIG. 4, performance of the process for combined interpolation and primary estimation, as just described, can result in an improvement in combined traces for the primaries 418, 420 and/or the multiples 422, 424, as represented by solid lines in panel C relative to the number of dots in panels A and B representing the received seismic data and that is subject only to preliminary interpolation, respectively.

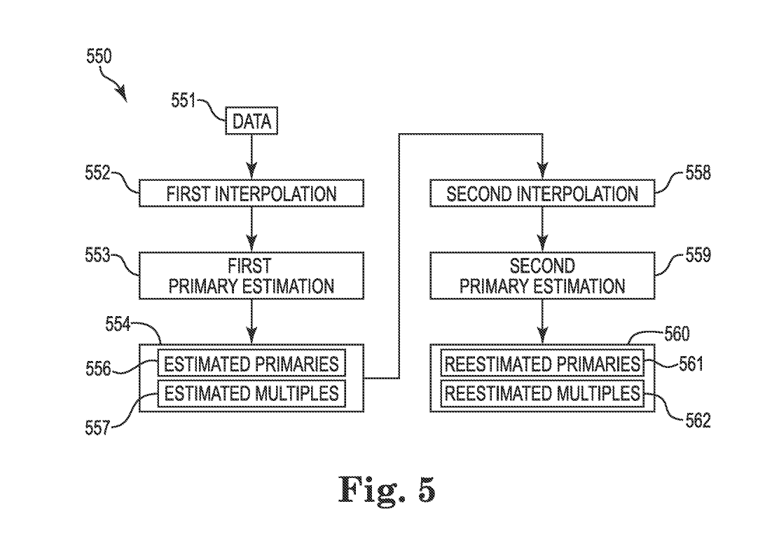

FIG. 5 illustrates a flowchart of an example of combined interpolation and primary estimation according to one or more embodiments of the present disclosure. The flowchart 550 in FIG. 5 illustrates differences between some approaches to marine seismic data processing in which seismic data may be interpolated only before applying a primary estimation technique and embodiments as described in the present disclosure.

The flowchart 550 in FIG. 5 illustrates an embodiment, for example, as described with regard to FIGS. 2-3, of marine seismic data processing of originally received seismic data 551. The processing can include performing a first interpolation 552 on the received seismic data 551 followed by a first primary estimation 553. The first primary estimation 553 can provide an output 554 that includes estimated primaries 556 separate from estimated multiples 557. The separate estimated primaries 556 and estimated multiples 557 then can each be processed by performing a second interpolation 558 on the output of the first primary estimation 553 followed by performing a second primary estimation 559 on the second interpolated seismic data. The second primary estimation 559 can provide an output 560 that includes reestimated primaries 561 separate from reestimated multiples 562, which can undergo combination into a single representation of the reestimated primaries 561 and reestimated multiples 562, for example, as shown in panel C of FIG. 3.

In some embodiments, the processing can include performing a third interpolation on the output of the second primary estimation and performing a third primary estimation on the third interpolated seismic date, where output of the third primary estimation can include further reestimated primaries and/or further reestimated multiples. In various embodiments, the processing can include fourth, fifth, sixth, etc., iterations of interpolation and primary estimation, as described with regard to FIG. 3.

In various examples, performance of a number of the interpolations can utilize execution of machine-readable instructions for a differential NMO technique and/or the performance of a number of the primary estimations can utilize execution of machine-readable instructions for an EPSI technique. Accordingly, FIG. 5 illustrates combined interpolation and primary estimation, such that each of the two techniques can make use of information generated by the other technique in accordance with one or more example embodiments of the present disclosure.

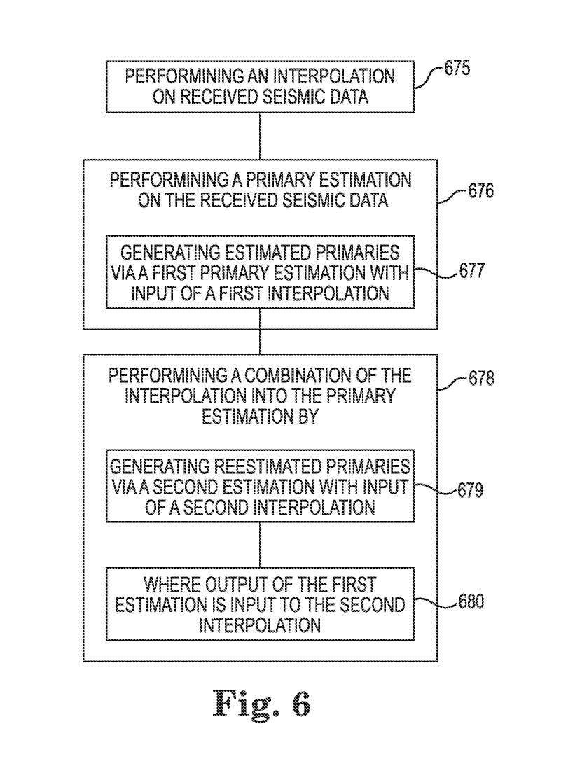

FIG. 6 illustrates another method flow diagram for combined interpolation and primary estimation according to one or more embodiments of the present disclosure. As described herein, methods for performing, determining, calculating, estimating, interpolating, etc., can be performed by a machine, for example, a computing device, processing at least received seismic data (a dataset) including at least one seismic event.

As shown at block 675 of FIG. 6, the method can include performing a first interpolation on the received seismic data, as described herein with regard to FIGS. 2-5. At block 676, the method can include performing a first primary estimation on received seismic data, as described herein with regard to FIGS. 2-5. At block 677, the method can include generating estimated primaries via the first primary estimation with input of the first interpolation. At block 678, the method can include performing a combination of interpolation and primary estimation. Performing the combination of interpolation and primary estimation at block 678 can include generating reestimated primaries via a second primary estimation with input of a second interpolation, as shown at block 679. As shown at block 680, output of the first primary estimation is input to the second interpolation, as described herein with regard to FIGS. 2-5.

In some embodiments, the combination can also include generating estimated multiples via the first primary estimation with input of the first interpolation and further generating reestimated multiples via a third primary estimation with input of a third interpolation. In at least one example, output of the first estimation is input to the third interpolation, as also described herein with regard to FIGS. 2-5.

In various embodiments, the method can include generating the reestimated primaries and the reestimated multiples via the estimated primaries and the estimated multiples output by the first estimation, and processing each separately with input of different second and third interpolations for the second and third estimations, respectively. The estimated primaries and the estimated multiples each being processed separately with the input of the different second and third interpolations can, in various embodiments, include processing each interpolation separately with its own different differential normal move out velocity. In various embodiments, the processing can include third, fourth, fifth, etc., iterations of reestimation with input of interpolations, as just described.

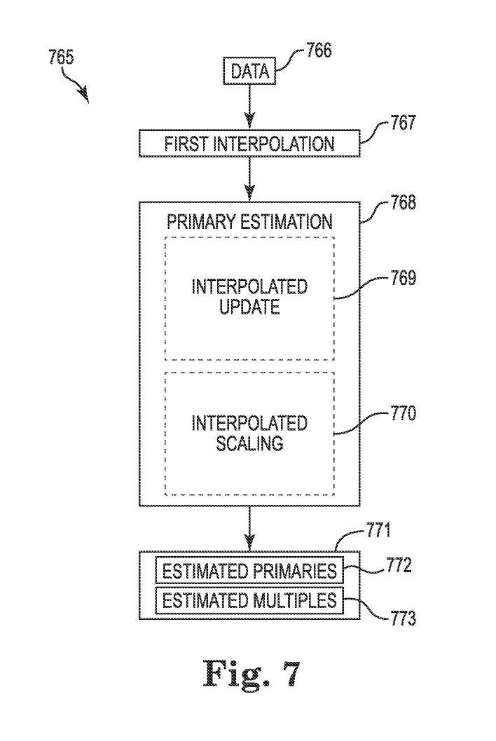

FIG. 7 illustrates a flowchart of an example of combined interpolation and primary estimation according to one or more embodiments of the present disclosure. As in FIGS. 5 and 6, the flowchart 765 in FIG. 7 illustrates differences between some approaches to marine seismic data processing in which seismic data may be interpolated only before applying a primary estimation technique and embodiments as described in the present disclosure.

The flowchart 765 in FIG. 7 illustrates an embodiment, for example, as described with regard to FIG. 4, of marine seismic data processing in which the received seismic data 766 undergoes a first interpolation 767 followed by a primary estimation 768. The primary estimation 768 can execute instructions such that an interpolated update 769 direction of a primary impulse response can be substituted for at least one calculation of an update direction thereof. Additionally or alternatively, an interpolated scaling 770 (e.g., a scaling factor) can be substituted for at least one calculation of scaling in order to scale the interpolated update. The primary estimation 768 can provide an output 771 that includes estimated primaries 772 and/or estimated multiples 773. In some embodiments, the estimated primaries 772 and estimated multiples 773 can be combined into a single representation, for example, as shown in panel C of FIG. 4.

In various examples, performance of the plurality of interpolations can utilize execution of machine-readable instructions to perform a differential NMO technique and/or the performance of the plurality of primary estimations can utilize execution of machine-readable instructions to perform an EPSI technique. Accordingly, FIG. 7 illustrates interpolation being incorporated inside a primary estimation by inversion such that during the inversion not everything has to be calculated, but portions can be interpolated in a more computationally efficient manner, for example, as described with regard to FIG. 4.

In accordance with a number of embodiments of the present disclosure, a geophysical data product may be generated. In various embodiments, generating the geophysical data product can include obtaining geophysical data from a marine seismic survey, as described herein, and processing the geophysical data. Processing the geophysical data can, among various embodiments, include performing a plurality of interpolations on the geophysical data and performing a plurality of primary estimations on the geophysical data, where performing the plurality of primary estimations can include generating estimated primaries via a first primary estimation with input of a first interpolation. Processing the geophysical data can, among various embodiments, further include performing a combination of interpolation and primary estimations by generating estimated primaries via a first primary estimation with input of the first interpolation and generating reestimated primaries via a second primary estimation with input of a second interpolation, where output of the first primary estimation is input to the second interpolation.

Geophysical data may be accessed, recorded, and/or stored on a non-transitory, tangible machine-readable medium that is, for example, suitable for importing onshore. The geophysical data product may be produced (e.g., recorded) by processing geophysical data offshore (by equipment on a marine seismic survey vessel) and/or onshore (at a facility on land) either within the United States or in another country. If the geophysical data product is produced offshore and/or in another country, it may be imported onshore to a facility in the United States. In some instances, once onshore in the United States, geophysical analysis may be performed on the geophysical data product. In some instances, geophysical analysis may be performed on the geophysical data product offshore. For example, performing the interpolation on obtained and/or received seismic data can be performed on data obtained as it is being measured offshore to facilitate other processing of the measured data either offshore or onshore. As another example, performing the primary estimation on the received seismic data can be performed on data that has already been measured offshore or onshore to facilitate other processing of the measured data either offshore or onshore.

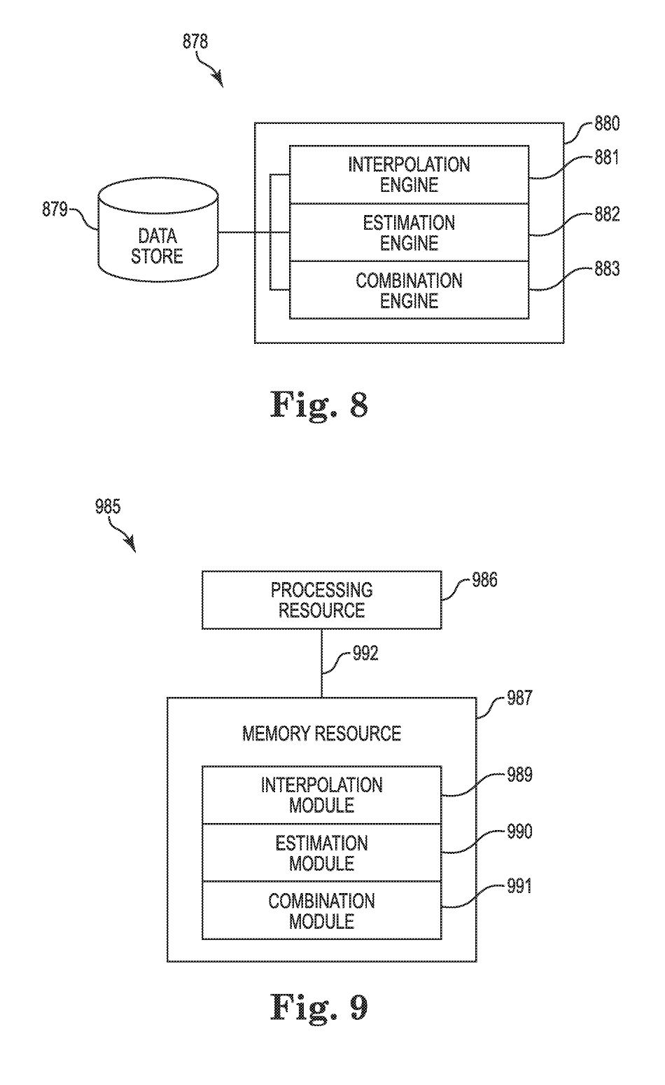

FIG. 8 illustrates a diagram of a system for combined interpolation and primary estimation according to one or more embodiments of the present disclosure. The system 878 can include a data store 879, a subsystem 880, and/or a number of engines, such as an interpolation engine 881, an estimation engine 882, and/or a combination engine 883, and can be in communication with the data store 879 via a communication link. The system 878 can include additional or fewer engines than illustrated to perform (execute) the various functions (actions) described herein. The system 878 can represent program instructions and/or hardware of a machine, such as machine 985 referenced in FIG. 9, etc. As used herein, an “engine” can include program instructions and/or hardware, but at least includes hardware. Hardware is a physical component of a machine that enables it to perform a function. Examples of hardware can include a processing resource, a memory resource, a logic gate, etc.

The number of engines can include a combination of hardware and program instructions that is configured to perform a number of functions described herein. The program instructions (e.g., software, firmware, etc.) can be stored in a memory resource (e.g., machine-readable medium (MRM), computer-readable medium (CRM), etc.) as well as in a hard-wired program (e.g., logic). The logic of hard-wired program instructions can be considered as both program instructions and hardware.

The interpolation engine 881 can include a combination of hardware and program instructions that is configured to determine a first interpolation of non-received seismic data based on received seismic data (traces), for example, as described with regard to FIGS. 1-6. In various embodiments, the interpolation engine 881 can include a combination of hardware and program instructions that are configured to execute the first interpolation by execution of machine-readable instructions for a differential NMO technique.

In various embodiments, the estimation engine 882 can include a combination of hardware and program instructions to determine at least one of estimated primaries and/or estimated multiples based on the received seismic data and the first interpolated seismic data, for example, as described with regard to FIGS. 2-6. In various embodiments, the estimation engine 882 can include a combination of hardware and program instructions that are configured to execute the primary estimation by execution of machine-readable instructions for an EPSI technique.

In various embodiments, the combination engine 883 can include a combination of hardware and program instructions to combine a second interpolation into the at least one of the estimated primaries or the estimated multiples. The combination can be performed such that the second interpolation uses information generated by determination of the at least one of the estimated primaries or the estimated multiples and a reestimation of the at least one of the estimated primaries or the estimated multiples uses information generated by the second interpolation, for example, as described with regard to FIGS. 2-6. In various embodiments, the combination engine 883 can include a combination of hardware and program instructions to enable the EPSI technique to include execution of an update of a primary impulse response (before imposing sparseness) by calculation of first update directions for at least some of the received seismic data and interpolation of second update directions for at least some of the first interpolated seismic data, which may reduce computational complexity as described with regard to FIG. 4. The interpolation of the second update directions for the at least some of the first interpolated seismic data can include execution of a differential NMO technique.

In various embodiments, the combination engine 883 can include a combination of hardware and program instructions that are configured to enable execution of the update to include scaling of the update with a scaling factor (that can be positive frequency independent), such that an objective function value decreases, by calculation of first scaling factors for at least some of the received seismic data and interpolation of second scaling factors for at least some of the first interpolated seismic data, which may reduce computational complexity as described with regard to FIG. 4. The interpolation of the second scaling factors for the at least some of the first interpolated seismic data can include execution of a differential NMO technique.

In various embodiments, the combination engine 883 can include a combination of hardware and program instructions that are configured to execute combination of the second interpolation into the reestimation of the at least one of the estimated primaries or the estimated multiples by execution of machine-readable instructions. In various embodiments, the system 878 can include an output engine including a combination of hardware and program instructions that are configured to output at least one of reestimated primaries and/or reestimated multiples.

FIG. 9 illustrates a diagram of a machine for combined interpolation and primary estimation according to one or more embodiments of the present disclosure. The machine 985 can utilize software, hardware, firmware, and/or logic to perform a number of functions. The machine 985 can be a combination of hardware and program instructions configured to perform (execute) the number of functions (actions). The hardware, for example, can include a number of processing resources 986 and a number of memory resources 987, such as a MRM, CRM, or other memory resources. The memory resources 987 can be internal and/or external to the machine 985. For example, the machine 985 can include internal memory resources and have access to external memory resources, among other embodiments. The program instructions (e.g., machine-readable instructions (MRI), computer-readable instructions (CRI), etc.) can include instructions stored on the MRM to implement a particular function. For example, a set of MRI can be executable by one or more of the processing resources 986. The memory resources 987 can be coupled to the machine 985 in a wired and/or wireless manner. For example, the memory resources 987 can be an internal memory, a portable memory, a portable disk, and/or a memory associated with another resource enabling the MRI to be transferred and/or executed across a network, such as the Internet. As used herein, a “module” can include program instructions and/or hardware, but at least includes program instructions.

Memory resources 987 can be non-transitory and tangible and can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory, optical memory, and/or a solid state drive (SSD), etc., as well as other types of MRM.

The processing resources 986 can be coupled to the memory resources 987 via a communication path 992. The communication path 992 can be local or remote to the machine 985. Examples of a local communication path can include an electronic bus internal to a machine, where the memory resources 987 are in communication with the processing resources 986 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 992 can be such that the memory resources 987 are remote from the processing resources 986, such as in a network connection between the memory resources 987 and the processing resources 986. That is, the communication path 992 can be a network connection. Examples of such a network connection can include a local area network (LAN), wide area network (WAN), personal area network (PAN), and the Internet, among others.

As shown in FIG. 9, the MRI stored in the memory resources 987 can be segmented into a number of modules 989, 990, 991 that when executed by the processing resources 986 can perform a number of functions. As used herein, a module includes a set of instructions included to perform a particular function (task or action). The number of modules 989, 990, 991 can be sub-modules of other modules. For example, an interpolation module 989 can be a sub-module of an estimation module 990 and/or the interpolation module 989 and the estimation module 990 can be contained within a single module. Furthermore, the number of modules 989, 990, 991 can include individual modules separate and distinct from one another. Examples are not limited to the specific modules 989, 990, 991 illustrated in FIG. 9.

Each of the number of modules 989, 990, 991 can include program instructions and/or a combination of hardware and program instructions that, when executed by a processing resource 986, can function as a corresponding engine as described with respect to FIG. 8. For example, the interpolation module 989 can include program instructions and/or a combination of hardware and program instructions that, when executed by a processing resource 986, can function as the interpolation engine 881, the estimation module 990 can include program instructions and/or a combination of hardware and program instructions that, when executed by a processing resource 986, can function as the estimation engine 882, and/or the combination module 991 can include program instructions and/or a combination of hardware and program instructions that, when executed by a processing resource 986, can function as the combination engine 883.

In various embodiments, the estimation module 990 can include instructions to perform (execute) a primary estimation by inversion on received seismic data. In various embodiments, the combination module 991 can include instructions to incorporate performance of interpolation during the performance of the primary estimation by inversion, for example, as described with regard to FIGS. 4 and 6. In various embodiments, the interpolation module 989 can include instructions executable to perform (execute) the interpolation by execution of machine-readable instructions for a differential NMO technique. In various embodiments, the interpolation module 989 can include instructions to perform (execute) a preliminary interpolation on the received seismic data prior to performance of the primary estimation by inversion, as described herein with regard to FIGS. 1-6. In various embodiments, the machine 985 can include an output module including instructions that are configured to output at least one of estimated primaries and/or estimated multiples.

The combination module 991 can, in various embodiments, include instructions executable to include interpolated seismic data within the primary estimation by inversion to substitute for a number of calculations during the performance of the primary estimation by inversion. To substitute for the number of calculations can, in various embodiments, include reduction of a number of calculations per iteration of the performance of the primary estimation by inversion, as described with regard to FIG. 4. In various embodiments, to substitute for the number of calculations can include at least one of substitution of an interpolated update direction of a primary impulse response for at least one calculation of an update direction and/or substitution of an interpolated scaling factor for at least one calculation of a scaling factor to scale an update such that an objective function value decreases.

Implementation of embodiments of the present disclosure can reduce computational costs of primary estimation by combining interpolation and primary estimation. For instance, embodiments of the present disclosure can replace a two-phase (prediction and subtraction) multiple removal approach, SRME, and/or Wemult and adaptive subtraction, which each may be computationally demanding and/or labor-intensive. In addition, embodiments may include an improved multiple removal method and/or wavelet estimation applied to primary estimation to improve reliability in terms of phase and/or amplitude. Further, shallow water data processing may be improved as compared to previous methodologies. Moreover, implementation of embodiments of the present disclosure may result in an improved understanding of inversion techniques, as processing is becoming more inversion-based by utilizing full wave form inversion, full wavefield migration, and/or EPSI techniques, among others.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
processing, by a machine, received seismic data, wherein the processing comprises:
performing, by the machine, a first interpolation on the received seismic data;
performing, by the machine, a first primary estimation on the first interpolated seismic data, wherein output of the first primary estimation includes:
estimated primaries; and
estimated multiples;
performing, by the machine, a second interpolation on the output of the first primary estimation; and
performing, by the machine, a second primary estimation on second interpolated seismic data, wherein output of the second primary estimation includes:
reestimated primaries; and
reestimated multiples.

2. The method of claim 1, comprising:
performing, by the machine, a third interpolation on the output of the second primary estimation; and
performing, by the machine, a third primary estimation on the third interpolated seismic date, wherein output of the third primary estimation includes:
reestimated primaries; and
reestimated multiples.

3. A method, comprising:
processing, by a machine, received seismic data, wherein the processing comprises:
performing, by the machine, a plurality of interpolations on the received seismic data;
performing, by the machine, a plurality of primary estimations on the received seismic data, wherein performing the plurality of primary estimations includes generating estimated primaries via a first primary estimation with input of a first interpolation; and
performing, by the machine, a combination of interpolation and primary estimation by:
generating reestimated primaries via a second primary estimation with input of a second interpolation;
wherein output of the first primary estimation is input to the second interpolation.

4. The method of claim 3, comprising:
generating estimated multiples via the first primary estimation with input of the first interpolation; and
generating reestimated multiples via a third primary estimation with input of a third interpolation;
wherein output of the first primary estimation is input to the third interpolation.

5. The method of claim 4, comprising:
generating the reestimated primaries and the reestimated multiples via the estimated primaries and the estimated multiples output by the first primary estimation, each being processed separately with input of different second and third interpolations for the second and third primary estimations, respectively.

6. The method of claim 5, wherein the estimated primaries and the estimated multiples each being processed separately with the input of the different second and third interpolations comprises performing each interpolation separately with its own different differential normal move out velocity.

7. The method of claim 3, wherein performing, by the machine, the plurality of interpolations, comprises:
execution of machine-readable instructions to perform a differential normal move out technique.

8. The method of claim 3, wherein performing, by the machine, the plurality of primary estimations, comprises:
execution of machine-readable instructions to perform a sparse inversion technique for primary estimation.

9. The method of claim 8, wherein performing, by the machine, the combination of interpolation and primary estimation, comprises:
performing the sparse inversion technique for primary estimation to include an update of a primary impulse response by:
calculation of first update directions for at least some of the received seismic data; and
interpolation of second update directions for at least some of the first interpolated seismic data.

10. The method of claim 9, wherein the interpolation of the second update directions for the at least some of the first interpolated seismic data includes execution of a differential normal move out technique.

11. The method of claim 9, wherein execution of the update includes scaling of the update with a scaling factor such that:
an objective function value decreases by calculation of first scaling factors for at least some of the received seismic data; and
interpolation of second scaling factors occurs for at least some of the first interpolated seismic data.

12. The method of claim 11, wherein the interpolation of the second scaling factors for the at least some of the first interpolated seismic data includes execution of a differential normal move out technique.

13. A system, comprising:
an interpolation engine to perform a first interpolation of non-received seismic data based on received seismic data;
an estimation engine to determine estimated primaries and estimated multiples based on the received seismic data and the first interpolated seismic data; and
a combination engine to combine a second interpolation into estimated primaries or the estimated multiples, such that:
the second interpolation uses information generated by the estimated primaries or the estimated multiples; and
a reestimation of the estimated primaries or the estimated multiples uses information generated by the second interpolation.

14. The system of claim 13, wherein the interpolation engine performs the interpolation by execution of machine-readable instructions for a differential normal move out technique.

15. The system of claim 13, wherein the estimation engine performs primary estimation by execution of machine-readable instructions for primary estimation using a sparse inversion technique.

16. The system of claim 13, wherein the combination engine performs the combination of the second interpolation into the estimated primaries by execution of machine-readable instructions.

17. The system of claim 15, wherein the combination engine enables the primary estimation by sparse inversion technique to include execution of an update of a primary impulse response by:
calculation of first update directions for at least some of the received seismic data; and
interpolation of second update directions for at least some of the first interpolated seismic data.

18. The system of claim 17, wherein the interpolation of the second update directions for the at least some of the first interpolated seismic data includes execution of a differential normal move out technique.

19. The system of claim 17, wherein execution of the update includes scaling of the update with a scaling factor such that:
an objective function value decreases by calculation of first scaling factors for at least some of the received seismic data; and
interpolation of second scaling factors occurs for at least some of the first interpolated seismic data.

20. The system of claim 19, wherein the interpolation of the second scaling factors for the at least some of the first interpolated seismic data includes execution of a differential normal move out technique.

21. The system of claim 13, comprising an output engine to output at least one of estimated primaries and estimated multiples.

22. A non-transitory machine-readable medium storing instructions executable by a processing resource to cause a machine to:
perform an primary estimation by inversion on received seismic data; and
incorporate performance of interpolation during the performance of the primary estimation by inversion.

23. The medium of claim 22, wherein the interpolation is performed by execution of machine-readable instructions for a differential normal move out technique.

24. The medium of claim 22, wherein the instructions executable to incorporate the performance of the interpolation during the performance of the primary estimation by inversion comprise instructions executable to:
include interpolated seismic data within the primary estimation by inversion to substitute for a number of calculations during the performance of the primary estimation by inversion.

25. The medium of claim 24, wherein to substitute for the number of calculations comprises reduction of a number of calculations per iteration of the performance of the primary estimation by inversion.

26. The medium of claim 24, wherein to substitute for the number of calculations comprises at least one of:
substitution of an interpolated update direction of a primary impulse response for at least one calculation of an update direction; and
substitution of an interpolated scaling factor for at least one calculation of a scaling factor to scale an update such that an objective function value decreases.

27. The medium of claim 22, comprising instructions to perform a preliminary interpolation on the received seismic data prior to performance of the primary estimation by inversion.

28. The medium of claim 22, comprising instructions to output at least one of estimated primaries or estimated multiples.

29. A method of generating a geophysical data product, the method comprising:
obtaining geophysical data from a marine seismic survey;
processing the geophysical data to generate the geophysical data product, wherein processing the geophysical data comprises:
performing a plurality of interpolations on the geophysical data;
performing a plurality of primary estimations on the geophysical data, wherein performing the plurality of primary estimations includes generating estimated primaries via a first primary estimation with input of a first interpolation; and
performing a combination of interpolation and primary estimations by:
generating reestimated primaries via a second primary estimation with input of a second interpolation;
wherein output of the first primary estimation is input to the second interpolation.

30. The method of claim 29, further comprising recording the geophysical data product on a non-transitory, tangible machine-readable medium suitable for importing onshore.
